(19) United States
(12) Patent Application Publication
(10) Pub. No.: US 2012/0292898 A1
(43) Pub. Date: Nov. 22, 2012

(54) Personality Exchange Tablet (PET) containing a DNA/DNAable vial insert

(76) Inventor: Jerry Ron Lewis, Alameda, CA (US)

(21) Appl. No.: 13/068,613

(22) Filed: May 16, 2011

(51) Int. Cl. B42D 15/00

(52) U.S. Cl. 283/75; 283/77

(57) ABSTRACT

My invention is called a “Personality Exchange Tablet” (PET) and represents a new product not seen before. The current similar products are baseball cards, coins, autographs, and memorabilia. A PET is designed to be a tradeable collectable or memorial for all people not just sports personalities. The key feature that this patent is to protect is that Personality Exchange Tablets contain a DNA (hair or other) sample of the given personality.

Moreover, a Personality Exchange Tablet is a credit card size tablet minted in metal with the picture, signature, and basic information of a given personality. Along with these common features a PET has a hole in the minted metal tablet where a DNA vial of the given personality is inserted to create one collectable unit.

The title “Personality Exchange Tablet” (PET) represents a new product not seen before. The current similar products are baseball cards, coins, autographs, and memorabilia. Designed to be a tradeable collectable, PETS have an actual piece of the person represented by containing either actual DNA or a DNAable (hair or other) sample of the given personality.

### BACKGROUND

A Personality Exchange Tablet (PET) is a credit card size tablet minted in metal with the picture, signature, and basic information of a given personality. Along with the above common features a PET has a hole or indentation minted into the tablet where a DNA/DNAable piece of the personality is inserted.

The tablets are more secure/durable version of sport collector cards but, a PET is designed for all famous personalities and not just for athletes.

As stated, the unique part of this design is that these Personality Exchange Tablets are minted with an indentation in the metal where a small glass or plastic vial containing a DNA or DNAable (hair, other) piece of the given personality is inserted and combined with the metal tablet to comprise one collectable unit.

This design of having a collectable for famous people and actually having a physical piece of the person represented contained in each tablet is my original design with a prototype currently in progress.

### DRAWING DESCRIPTION

FIG. 1A shows the front view of the Personality Exchange Tablet and is described as follows:

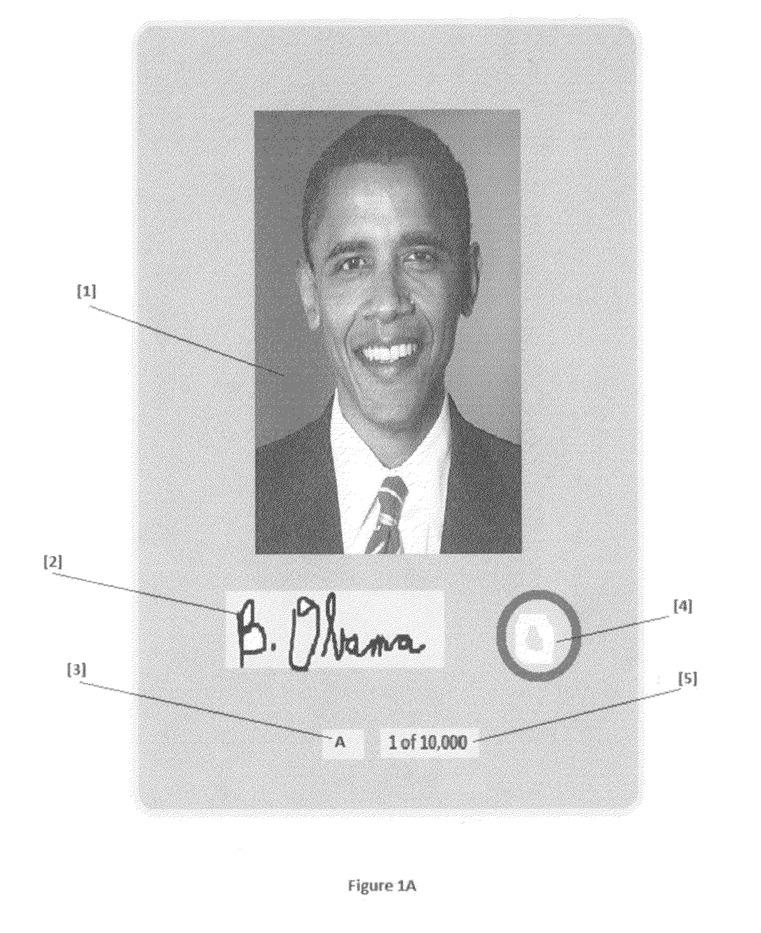

[1] Porcelain Picture.

[2] signature stamped into the metal.

[3] series Number stamped into the metal.

[4] DNA vial inserted into a hole drilled in the metal.

[5] sequence Number stamped into the metal.

What is claimed:

1. Personality exchange tablets (pets) are a more secure/durable version of sport collector cards but pets are minted in metal and, pets are designed for all famous personalities and not just for athletes:
The unique part of this design is that these Personality Exchange Tablets are minted in metal with an indentation where a small glass or plastic vial containing a DNA or DNAable (hair, other) piece of the given personality is inserted and combined with the metal tablet to comprise one collectable unit.
This design of having a collectable for famous personalities and actually having a physical piece of the person represented contained in each tablet is my original design with a prototype currently in progress.
